(19) United States
(12) Patent Application Publication
(10) Pub. No.: US 2011/0094619 A1
(43) Pub. Date: Apr. 28, 2011

(54) SYSTEM FOR DISPENSING A FLUID IN NON-CONTROLLED ENVIRONMENTS

(76) Inventors: Colin Steel, London (GB); Roger Pettitt, Amersham (GB); Paul Crosby, London (GB); Svein-Erik Lindgaard, Oslo (NO)

(21) Appl. No.: 12/864,667

(22) PCT Filed: Feb. 9, 2009
(86) PCT No.: PCT/US09/33551

§ 371 Date: Nov. 30, 2010

(30) Foreign Application Priority Data
Feb. 7, 2008 (GB) 0802216.2

(51) Int. Cl. B67C 3/02; B65D 71/00; F16B 2/20

(52) U.S. Cl. 141/27; 206/571; 24/457

(57) ABSTRACT

The present invention provides a dispenser cassette (110) which provides at least one product dispense vial (122) to be filled. The cassette provides a filtrate conduit (128) extending between the dispense vial and a filter unit (116) so that flowpath (120) of the filtrate conduit and the dispense vial is provided and maintained as an environmentally-controlled, or GMP-compliant, volume. The resulting product dispensed into the dispense vial is thus dispensed in a GMP-compliant environment.

### FIELD OF THE INVENTION

The present invention relates to the field radiopharmaceutical preparation. More specifically, the present invention relates to a device and method for good manufacturing practices (GMP) dispensing in a non-controlled environment.

### BACKGROUND OF THE INVENTION

The dispensing philosophy of a sterile kit and associated hardware have been reviewed and approved for use by UK regulatory authorities (MHRA). This enables the delivery of injectable radiopharmaceuticals directly from a shielded enclosure whilst utilizing aseptic dispensing techniques. FIG. 1 depicts a schematic of a dispense system 10 of the prior art as operated within the confines of a laminar flow cabinet which ensures all connections may be made in a controlled, desirably a GMP-compliant, environment. Dispense system 10 accepts a feed fluid into a bulk collection vial 12 through the “Product Inlet”. The feed fluid is typically provided by a separate manufacturing unit either directly or via an alternate storage or transportation device through the Product Inlet. A feed fluid flowpath leads the fluid from vial 12 through a first valve 14 to a syringe pump 16. Valve 14 actuates so that dispensement from pump 16 is directed towards a second valve 18. Valve 18 either directs gas flow from a filter integrity test unit 20 towards a dead-end filter 22 for integrity testing, or directs the feed fluid through filter 22. A filtrate fluid flow path leads from filter 22 to a series of valves 24, 26, which selectably direct the filtrate fluid to one of a number of product dispense vials 28, 30, 32.

Application of this dispensing system within other radiopharmaceutical production laboratories, however, is limited as the dispensing kit had been designed to work with a specific hardware design integrated within a GMP shielded enclosure. The associated hardware would be difficult to retrofit into an existing shielded enclosure. In addition, other radiopharmaceutical production facilities may not be GMP compliant which may undermine the dispensing philosophy and thus not gain MHRA approval.

There is therefore a need for adapting a GMP dispensing system for use in an uncontrolled, in even non-GMP compliant, laboratory. There is also a need for a device and apparatus which may be retrofitted to an existing system for allowing GMP compliant dispensing in an uncontrolled or non-GMP compliant environment, ie, outside of an existing GMP compliant dispense area.

In order to further reduce operator exposure to hazardous liquids which may be dispensed by the system of the present invention, there is also a need for a device which will remotely separate the filling hardware from the dispense vials. To further assist the operator, there is a need for a device which helps ensure proper insertion and retention of filling hardware into a dispense vial.

### SUMMARY OF THE INVENTION

The present invention provides a method for introducing a GMP compliant dispensing system into an environmentally-uncontrolled laboratory.

The present invention provides a dispenser cassette which provides at least one product dispense vial to be filled. The cassette provides a filtrate conduit extending between the dispense vial and a filter unit so that flowpath of the filtrate conduit and the dispense vial is provided and maintained as an environmentally-controlled, or GMP-compliant, volume. The resulting product dispensed into the dispense vial is thus dispensed in a GMP-compliant environment.

In one preferred embodiment, the present invention provides a dispenser cassette for dispensing a fluid provided by a fluid source. The cassette includes a housing defining a housing cavity. The housing supports in the cavity the fluid transfer components for directing the fluid from the fluid source to at least one product dispense vial. The housing includes an elongate feed flowpath, an elongate filtrate flowpath, and a sterilizing filter providing a filter element positioned in fluid communication with the delivery passageways of the feed and filtrate flowpaths. A pump means is operably connected to the feed flowpath for directing a fluid through the filter element. A first valve provides selectable fluid communication between the pump and either the fluid source or the filter. The product dispense vial has a vial cavity which is provided in fluid communication with the delivery passage of the filtrate flowpath. Additionally, the vial cavity and the delivery passage of the filtrate flowpath are provided as an environmentally-controlled volume. The cassette may further include a controller for selectively operating the syringe pump and the valves so as to direct fluid from the fluid source to the product dispense vial.

The present invention also provides a laminar flow hood adaptor defining an adaptor cavity. The laminar flow hood adaptor connects a laminar flow hood, itself having a primary hood cavity, such that the adaptor cavity is placed in fluid communication with the primary hood cavity so as to thereby conduct GMP-compliant air flow from said primary hood cavity through said adaptor cavity. The adaptor thus enlarges the GMP-compliant volume of the laminar flow hood. The adaptor cavity supports a dispenser cassette therein which includes the necessary conduits, valves, and pump mechanism for GMP dispensing of a product fluid into product vials.

The present invention also provides a needle plate lift mechanism for separating filled dispense vials from any fluid delivery and/or venting needles inserted into the vial to effect fluid transfer.

Furthermore, the present invention provides a vial clip for directing and maintaining one or more needles used for dispensing operations through the pierceable septum of a dispense vial.

### BRIEF DESCRIPTION OF THE DRAWINGS

FIG. 1 depicts a schematic of a dispense system of the prior art.

FIG. 2 depicts a dispenser cassette of the present invention.

FIG. 3 depicts an alternate embodiment of a dispense cassette of the present invention.

FIG. 4 depicts an alternate embodiment of a dispenser cassette of the present invention which includes needle plate hardware.

FIG. 5 depicts the fluid transfer mechanisms of a dispense cassette of the present invention.

FIG. 6 depicts a flow hood adaptor having an environmentally-controlled dispensing kit of the present invention for dispensing into an uncontrolled environment.

FIG. 7 depicts another dispensing kit of the present invention employing gas detectors with the fluid conduit.

FIG. 8 depicts yet another dispensing kit adapted to be connected to a prior art dispense system while providing a filtrate flowpath that is maintained at an environmentally-controlled condition.

FIG. 9 depicts a needle plate lift mechanism of the present invention.

FIG. 10 depicts the needle plate lift mechanism of FIG. 9 in a retracted position allowing removal of the vials.

FIG. 11 depicts a vial clip of the present invention.

FIG. 12 depicts a cross-sectional view of the vial clip of FIG. 11.

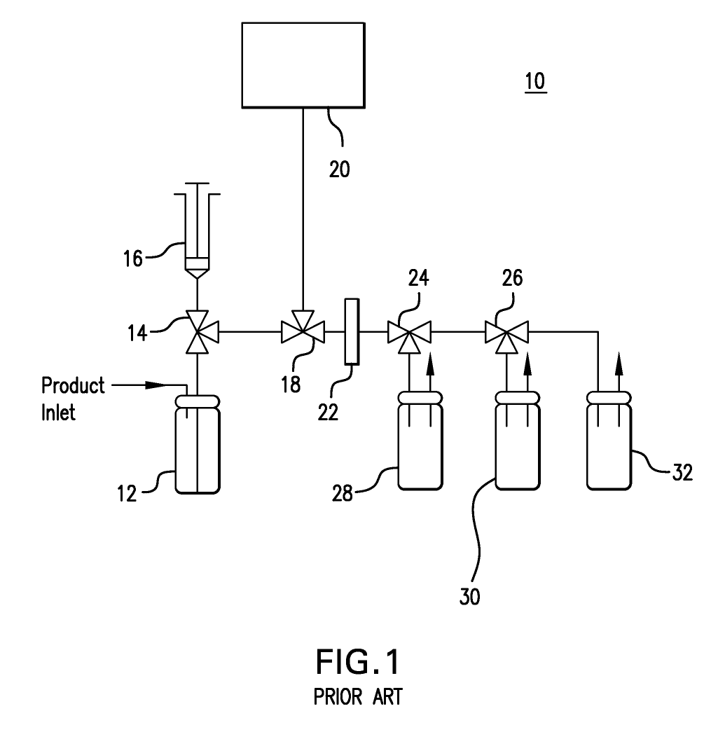

### DETAILED DESCRIPTION OF THE PREFERRED EMBODIMENT

The present invention is a method for providing a sterile dispensement of a pharmaceutical from a non-sterile dispense system. Alternatively, the present invention adapts a GMP-compliant dispensing system for use in an uncontrolled, a non-sterile, or a non-GMP-compliant, environment. GMP is the short-hand notation for good manufacturing practice, those standards required by the pharmaceutical industry for sterile or controlled production of pharmaceutical products. Alternatively still, the present invention may be adapted for dispensing any fluid which must be dispensed in a ‘clean’ environment. In one embodiment, the present invention provides a kit for attachment to an existing dispenser. The kit includes the dispensing hardware required to direct the dispensed fluid from the collection vial to various product vials. Alternatively, the present invention provides the entire dispensing hardware as a complete preassembled sterile kit. The kit includes a feed fluidpath from the collection vial (aka a product dispense vial), a filter, and associated tubing connecting each dispensing vial so that the environment between the filter and the interior of the dispensing vials is provided and maintained as an environmentally-controlled, desirably a sterile, and more desirably a GMP-compliant, dispense system. The kit also includes any necessary valving between the filter and the collection vial, e.g., when more than one dispense vial is to be provided. Desirably, the kit includes associated tubing leading to the filter from a filter integrity test source for integrity testing of the filter after flowing through the filter. The kit is desirably provided as a self-contained cassette with appropriate connections for a source of product fluid and the integrity test source. The kit may also include a needle plate for simultaneously lifting all of the necessary fluid conduits from the collection vials once dispensing is complete.

In one embodiment, the present invention provides the kit for a single-use dispense into the provided product vials. Alternatively, the present invention further provides an adaptor for a laminar flow hood so as to allow the volume under the laminar flow hood to include the kit and to allow for subsequent replacement of the dispense vials within the adaptor while connected with the laminar flow hood and thus provide for continued dispensing within a controlled environment.

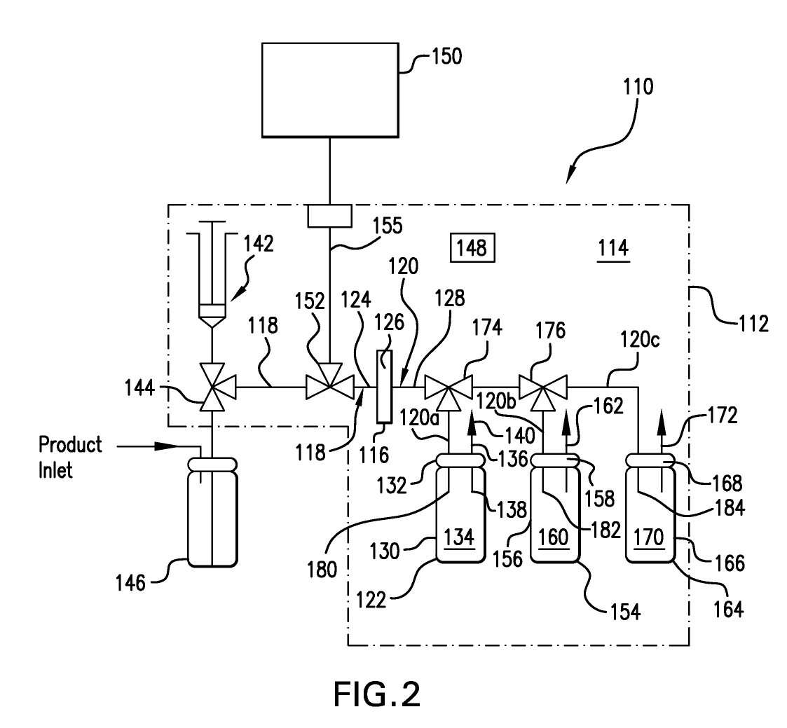

FIG. 2 is a schematic for a GMP-compliant dispensing cassette 110 of the present invention. Dispensing system 110 is shielded within a cassette housing 112 as represented by the dotted line. Housing 112 defines a housing cavity 114 which supports the fluid transfer mechanisms of dispense cassette 110. Housing cavity 114 is accessible to a user for removing the product dispense vials. Dispense cassette 110 includes a sterilizing filter 116. Filter 116 is desirably a dead-end design filter in which filters a source fluid into a cleaner filtrate. A dead-end filter is sufficient when dispense cassette 110 is used as a single-use system and even for most dispenses should it be re-used. Filter 116 desirably provides a 0.22 micron filter although the filter specifications may be selected as desired for the particular operation. Dispense cassette 110 provides a feed flowpath 118 through which a source fluid flows from an exterior fluid source to filter 116. Dispense cassette 110 also provides a filtrate flowpath 120 leading from filter 116 to at least one product dispense vial 122. Feed flowpath 118 defines a feed passageway 124, filter 116 defines a filter passageway 126, and filtrate flowpath 128 defines a filtrate flowpath 128. Feed passageway 124 is thus in filtered fluid communication with filtrate passageway 128 through filter passageway 126.

Product dispense vial 122 includes an open container body 130 sealed close by an elastomeric septum 132 and defines a vial cavity 134. Vial cavity 134 is in fluid communication with filtrate passageway 126 of filtrate flowpath 120 through needle 180. Filter 116, filtrate flowpath 120, and dispense vial 122 are connected together in an environmentally-controlled environment, desirably a sterile or a GMP-compliant environment, so that all of the fluid flowspace beyond filter 116 is continues to meet the standards of the controlled environment. Desirably, a Class A environment is provided and maintained by the present invention. An elongate vent cannula, or vent needle, 136 may also be provided extending through septum 132 so as to allow any entrapped air within cavity 134 to escape while still maintaining the product filtrate fluid within vial 122. Vent cannula 136 typically includes an elongate hollow vent conduit body 138 supporting a filtration media 140 therein for allowing air to vent from vial cavity 134 while maintaining the controlled environment thereof.

Dispense cassette 110 includes a pump 142 operably connected to feed flowpath 118 for directing a fluid through filter 116. Pump 142 is desirably a syringe pump which is electrically or pneumatically controlled to draw a source fluid therein and to then expel the source fluid back out. A first valve 144 operably connected to feed flowpath 118 provides selectable fluid communication either between pump 142 and the bulk collection vial 146 or between pump 114 and filter 116. Valve 144 may be a stopcock valve although any valve useful for performing the same function may be employed.

Dispense cassette 110 further includes a PLC controller 148 for selectively operating syringe pump 142 and valve 144 so as to direct fluid from fluid source 146 to product dispense vial 122. For convenience, associated electrical connections from controller 148 are not shown in FIG. 2. Alternatively, dispense cassette 110 may include connectors for mating with an exterior controller or hardware platform which provides appropriate actuation of the elements within housing 112.

As shown in FIG. 2, dispense cassette 110 provides connections to an integrity test unit 150 for integrity testing of the filter. For this purpose a second valve 152 is operably connected to feed flowpath 118 so as to provide selectable communication either between filter 116 and integrity test unit 150 or between pump 142 and filter 116. An integrity fluid conduit 155 is connected to second valve 152 and extends outside of housing 112 for connection to integrity test unit 150. A suitable integrity test unit 150 may be selected from the Palltronic® Flowstar XC filter integrity test instruments sold by Pall Corporation of East Hills, N.Y. When dispensing radioactive fluids with a cassette of the present invention, the integrity test unit may be located outside of the hot cell while still being connectable to second valve 152 via conduit 155.

The present invention contemplates that it would be desirable to provide more than one product dispense vial for dispensing the filtrate fluid flowing through filter 116 into. As shown in FIG. 2, a second product dispense vial 154 and a third product dispense vial 164 are provided for this purpose. Second product dispense vial 154 includes an open container body 156 sealed close by an elastomeric septum 158 and defines a vial cavity 160. Vial cavity 160 is in fluid communication with filtrate passageway 126 of filtrate flowpath 120 through needle 182. Third product dispense vial 164 includes an open container body 166 sealed close by an elastomeric septum 168 and defines a vial cavity 170. Vial cavities 160 and 170 are in fluid communication with filtrate passageway 126 of filtrate flowpath 120 through needle 184. Similarly, second and third vials 154 and 164 are connected to filter 116 and filtrate flowpath 120 in an environmentally-controlled environment, desirably a GMP-compliant environment, so that all of the fluid flowspace beyond filter 116 continues to meet the standards of the controlled environment. Vent cannulas 162 and 172, each of similar construction to vent cannula 136 are provided to extend through septum 158 and 168, respectively, so as to allow any entrapped air within cavity 160 and 170, respectively, to escape while still maintaining the product filtrate fluid within vial 154 and 164, respectively, as well as the environmentally-controlled conditions within the vials.

In order to selectably direct flow into each of these additional product dispense vials, dispense cassette 110 incorporates third valve 174 and fourth valve 176 into filtrate flowpath 120. Third valve 174 is operably connected to filtrate flowpath 120 to provide selectable fluid communication either between filter 116 first product dispense vial 122 or between filter 116 and fourth valve 176. Fourth valve 176 is operably connected to filtrate flowpath 120 to provide selectable fluid communication either between third valve 174 and second product dispense vial 154 or between third valve 174 and third product dispense vial 164.

To ensure filtrate flowpath integrity, each of segments 120a, 120b, and 120c of filtrate flowpath 120, which connect to vials 122, 154, and 164, respectively, include an elongate dispense needle 180, 182, and 184, respectively, which extends through septum 132, 158, and 168, respectively. Each dispense needle defines a opposed first and second open ends and an elongate needle flowpath extending in open fluid communication therebetween. Each of needles 180, 182, and 184 have a cross-sectional diameter which ensures that the septum through which it is inserted is able to fully seal about the needle so as to maintain the environmental integrity of its respective vial cavity as well as to re-seal as the needle is withdrawn therefrom. Each vent cannula provides a similar feature so as to maintain septum and vial integrity.

In operation, bulk collection vial 146 is connected to feed flowpath 118 at a location outside of housing 112. Valve 144 is actuated to allow pump 142 to draw the fluid from source 146 thereinto. Valve 144 is then actuated to allow pump 142 to expel the fluid from pump 142 towards second valve 152. Valve 152 directs the fluid flow through filter 116 into filtrate flowpath 120. The purified fluid may then be directed, according to the actuation of third valve 174 and fourth valve 176 into product dispense vials 122, 154, and/or 164. Once the product dispense vials have received the appropriate amount of fluid, valve 152 may be actuated to direct the flow from the integrity test unit 150 to filter 116 to perform an integrity test of the filter. Once completed each vial may be removed from its respective needle 180, 182, or 184 for transfer towards an end use. The vent cannulas would also desirably be removed at this time.

It is contemplated that the interior volume of pump 142 may be smaller than either of vials 122, 154, and 164. Therefore, pump 142 would likely undergo multiple intake and expulsion cycles to direct the feed fluid to its appropriate destination. Alternatively, pump 142 may have a large interior volume which is sufficient to hold and expel all of the source fluid in a single expulsion stroke. In either case, one of ordinary skill in the art would know to provide the proper actuation control for pump 142 and for first valve 144. As noted hereinabove, actuation of pump 142 and valves 144, 152, 174 and 176 may be directed by an onboard PLC controller or by an off-unit hardware platform which holds and operates dispense cassette 110.

Additionally, dispense cassette 110 may be delivered in a sterile polymer bag to further protect the controlled environment within the filtrate flowpath and the dispense vials.

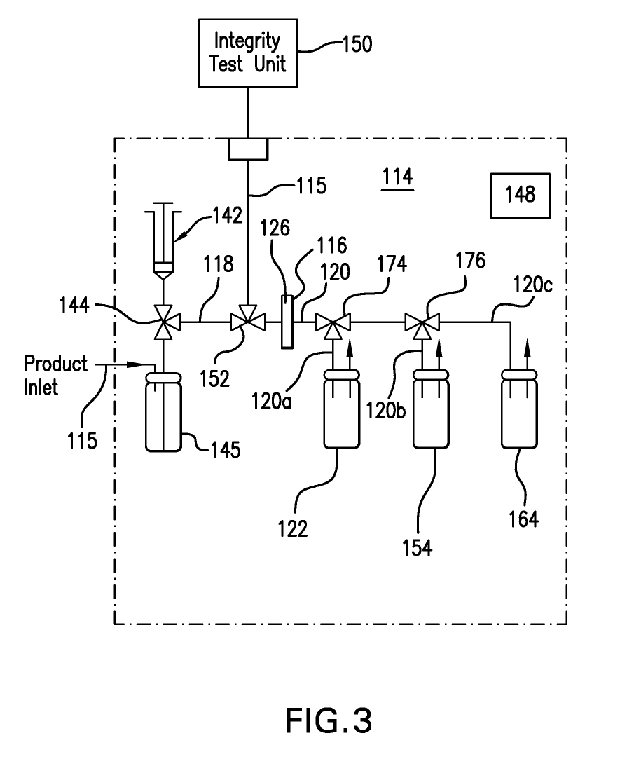

FIG. 3 depicts an alternate embodiment of dispense cassette 110, which incorporates a bulk collection vial 145 between the fluid source input and first valve 144. In this embodiment, bulk collection vial 145 is also located within cavity 114 of housing 112. Bulk collection vial 145 may be initially filled through a product inlet conduit 115. Dispensing operations would otherwise be similar as described hereinabove. The fluid in bulk collection vial 145 would first be drawn through valve 144 into pump 142. Valve 142 would then actuate to allow pump 142 to dispense through feed flowpath 118, through properly actuated valve 152 and through the media 126 of filter 116. The filtrate emerging from filter 116 flows through filtrate flowpath 120 so as to be directed via valve 174 into either flowpath 120a into product dispense vial 122 or through valve 176 either through flowpath 120b into product dispense vial 154 or through flowpath 120c into product dispense vial 164. Operation of the valves and pump would be directed by controller 148. Additionally, integrity test unit 150 is connectable to cassette 110 via conduit 155 to provide integrity testing of filter 116.

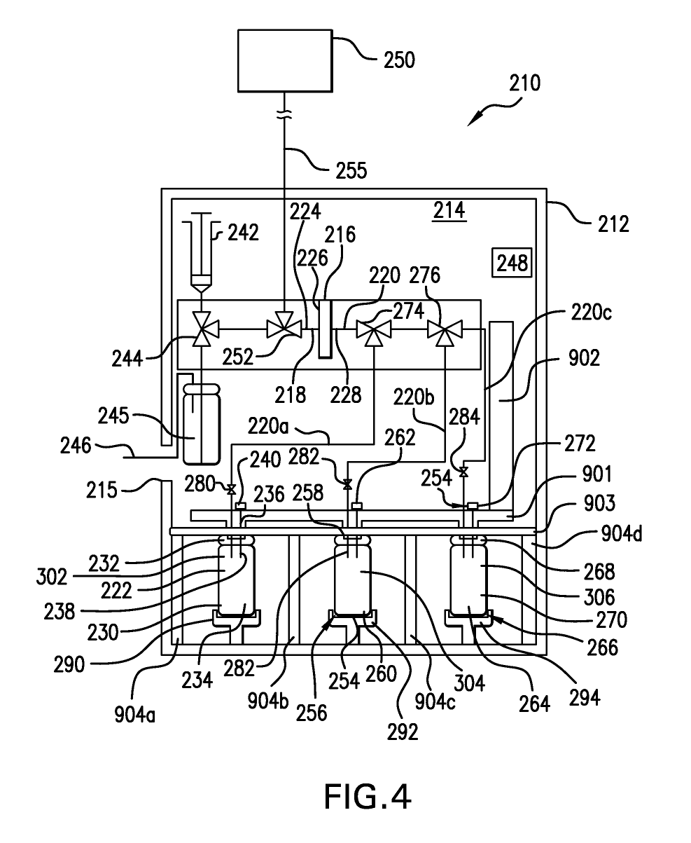

FIG. 4 depicts a dispenser cassette 210 of the present invention. Cassette 210 is similar to cassette 110, and like numbering will indicate like components. Cassette 210 further incorporates needle lifting hardware which separates the vial from the fluid and vent needles and reduces operator exposure to the radioactivity of certain radiopharmaceutical product fluids. Cassette 210 fits within the lead shielded laminar flow cabinet so that environmentally controlled air may enter the cassette cavity during fluid dispensing. Additionally, the lead shielding of the cabinet provides additional protection for the operator of the cassette while handling the product dispense vials.

Dispensing system 210 is shielded within a cassette housing 212. Housing 212 defines a housing cavity 214 which supports the fluid transfer mechanisms of dispense cassette 210. Housing 212 allows cavity 214 to be accessible to the operator so that the product dispense vials may be removed and inserted. Dispense cassette 210 includes a sterilizing filter 216. Filter 216 is desirably a dead-end design filter in which filters a source fluid into a cleaner filtrate. Dispense cassette 210 provides a feed flowpath 218 through which a source fluid flows from an exterior fluid source through cassette 210. Dispense cassette 210 also provides a filtrate flowpath 220 leading from filter 216 to at least one product dispense vial 222. Feed flowpath 218 defines a feed passageway 224, filter 216 defines a filter passageway 226, and filtrate flowpath defines a filtrate flowpath 228. Feed passageway 224 is thus in filtered fluid communication with filtrate passageway 228 through filter passageway 226.

Product dispense vial 222 includes an open container body 230 sealed closed by an elastomeric septum 232 and defines a vial cavity 234. Vial cavity 234 is in fluid communication with filtrate passageway 226 of filtrate flowpath 220. Filter 216, filtrate flowpath 220, and dispense vial 222 are connected together in an environmentally-controlled environment, desirably a GMP-compliant environment, so that all of the fluid flowspace beyond filter 216 is continues to meet the standards of the controlled environment. An elongate vent cannula 236 may also be provided extending through septum 232 so as to allow any entrapped air within cavity 234 to escape while still maintaining the product filtrate fluid within vial 222. Vent cannula 236 typically includes an elongate hollow vent conduit body 238 supporting a filtration media 240 therein for allowing air to vent from vial cavity 234 while maintaining the controlled environment within the vial cavity.

Dispense cassette 210 includes a pump 242 operably connected to feed flowpath 218 for directing a fluid through filter 216. Pump 242 is desirably a syringe pump which is electrically or pneumatically controlled to draw a source fluid therein and to then expel the source fluid back out. A first valve 244 operably connected to feed flowpath 218 provides selectable fluid communication either between pump 242 and bulk collection vial 245 or between pump 242 and filter 216. Housing 214 defines an aperture 215 through which a feed fluid is provided from a feed fluid source (not shown but denoted by the reference number 246).

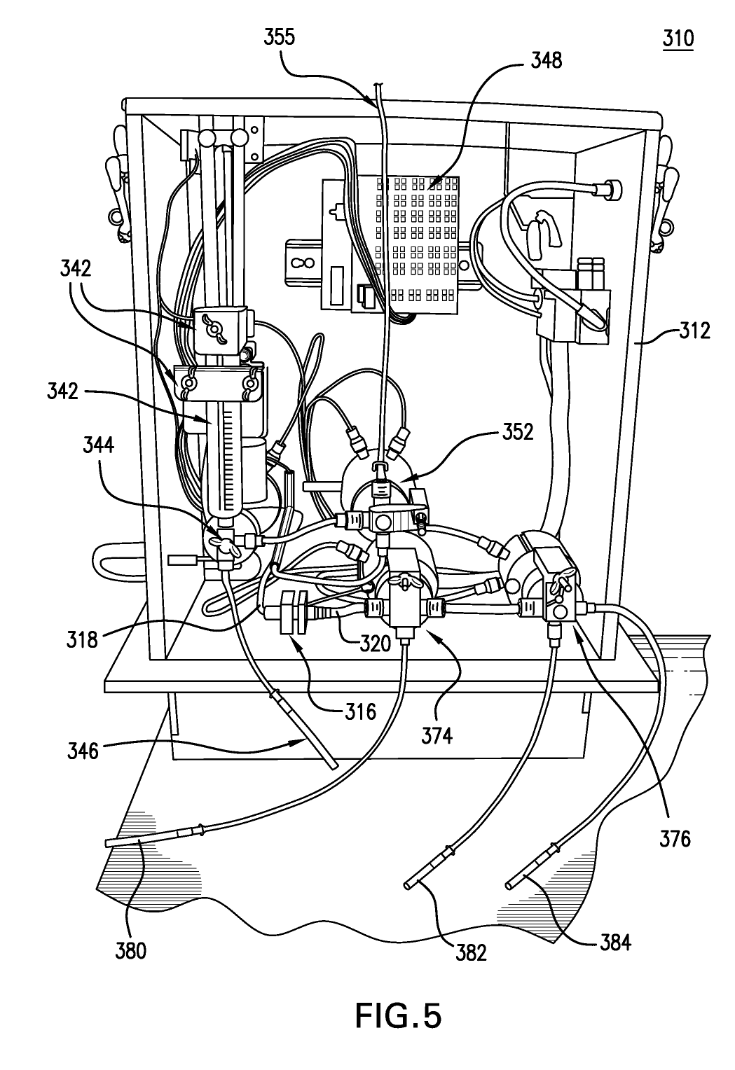

Dispense cassette 210 may further include a PLC controller 248 for selectively operating syringe pump 242 and valve 244 so as to direct fluid from fluid source 246 to product dispense vial 222. For convenience, associated electrical connections from controller 248 are not shown in FIG. 5. Alternatively, it is further contemplated that dispense cassette 210 may include connectors for mating with an exterior controller or hardware platform which provides appropriate actuation of the elements within housing 212.

As shown in FIG. 4, dispense cassette 210 provides connections to an integrity test unit 250 for filter integrity testing. For this purpose a second valve 252 is operably connected to feed flowpath 218 so as to provide selectable fluid communication either between pump 242 and filter 216, or the integrity test unit 250 and filter 216. An integrity fluid conduit 255 is connected to second valve 252 and extends outside of housing 212 for connection to integrity test unit 250. It is desirable to perform the integrity test on the filter after fluid is flowing through filter 216.

The present invention contemplates that it would be desirable to provide more than one product dispense vial for dispensing the filtrate fluid flowing through filter 216 into. As shown in FIG. 5, a second product dispense vial 254 and a third product dispense vial 264 are provided for this purpose. Second product dispense vial 254 includes an open container body 256 sealed close by an elastomeric septum 258 and defines a vial cavity 260. Vial cavity 260 is in fluid communication with filtrate passageway 226 of filtrate flowpath 220. Third product dispense vial 264 includes an open container body 266 sealed close by an elastomeric septum 268 and defines a vial cavity 270. Vial cavities 260 and 270 are in fluid communication with filtrate passageway 226 of filtrate flowpath 220. Similarly, second and third vials 254 and 264 are connected to filter 216 and filtrate flowpath 220 in an environmentally-controlled environment, desirably a GMP-compliant environment, so that all of the fluid flowspace beyond filter 216 continues to meet the standards of the controlled environment. Vent cannulas 262 and 272, each of similar construction to vent cannula 236 are provided to extend through septum 258 and 268, respectively, so as to allow any entrapped air within cavity 234 to escape while still maintaining the product filtrate fluid within vial 222 as well as the environmentally-controlled conditions within the vials.

In order to selectably direct flow into each of these additional product dispense vials, dispense cassette 210 incorporates third valve 274 and fourth valve 276 into filtrate flowpath 220. Third valve 274 is operably connected to filtrate flowpath 220 to provide selectable fluid communication either between filter 216 first product dispense vial 222 or between filter 216 and fourth valve 276. Fourth valve 276 is operably connected to filtrate flowpath 220 to provide selectable fluid communication either between third valve 274 and second product dispense vial 254 or between third valve 274 and third product dispense vial 264.

To ensure feed flowpath integrity, each of segments 220a, 220b, and 220c of filtrate flowpath 220, which connect to vials 222, 254, and 264, respectively, include an elongate dispense needle 280, 282, and 284, respectively, which extends through septum 232, 258, and 268, respectively. Each dispense needle defines a opposed first and second open ends and an elongate needle flowpath extending in open fluid communication therebetween. Each of needles 280, 282, and 284 have a cross-sectional diameter which ensures that the septum through which it is inserted is able to fully seal about the needle so as to maintain the environmental integrity of its respective vial cavity as well as to re-seal as the needle is withdrawn therefrom. Each vent cannula provides a similar feature so as to maintain septum, vial, and filtrate flowpath integrity.

Dispense cassette 210 further includes vial supports 290, 292, and 294 for holding the dispense vials 222, 254 and 264 thereon. An elongate planar vial retaining plate 308 is fixed across each of vials 230, 254, and 264 so as to be in abutting engagement with septums 232, 258 and 268. Vial retaining plate 308 defines apertures therethrough in overlying registry with vial cavities 302, 304, and 306 so as to allow needles 280, 282, and 284 of filtrate flowpath 220 and the associated vent cannulas to extend therethrough.

Cassette cavity 214 further includes therein an elongate planar needle plate 310 and a needle plate lifting mechanism 312 for raising needles 280, 282, and 284 as well as vent cannulas 236, 262 and 272 out from their respective vial septums and clear of vial retaining plate 308. Needle plate lifting mechanism 312 is desirably an automated pneumatic or electro-mechanical device, such as a piston cylinder. Needle plate 310 defines apertures therethrough in spaced registry over vial cavities 302, 304, and 306. Each of needles 280, 282, and 284 and vent cannulas 236, 262 and 272 are held and moved by needle plate 310 as it is raised from vial retaining plate 308 by lifting mechanism 312. Needle plate 310 is thus caused to move between a first position whereby needles 280, 282, and 284 and vent cannulas 236, 262 and 272 extend through the respective septums of vials 222, 254, and 264, and a second position whereby each of the needles and vent cannulas are raised clear thereof so that the product vials may be removed from cassette 210.

Additionally, cassette 210 provides posts 316a-d to which vial retaining plate 308 is fixed so as to remain stationary while needle plate 310 is lifted away therefrom. Once needles 280, 282, and 284 and vent cannulas 236, 262 and 272 are clear of septums 232, 258 and 268, product vials 222, 254 and 264 may be accessed and removed from cassette 210.

In operation, fluid source 246 is connected to feed flowpath 218 at a location outside of housing 212. The feed fluid from fluid source 246 passes through aperture 215 of cassette housing 212 and into bulk collection vial 245. The fluid transfer is accomplished by pump 242, while valve 244 is properly actuated, to draw the fluid from source 246 into bulk collection vial 245 and then thereinto pump 242 itself. Valve 244 is then actuated to allow pump 242 to expel the fluid from pump 242 towards second valve 252. Valve 252 may be actuated to direct the fluid flow towards integrity test unit 250 where so a quality assessment of the fluid may be performed. Valve 252 may then, or alternatively, direct the fluid flow through filter 216 into filtrate flowpath 220. The purified fluid may then be directed, according to the actuation of third valve 274 and fourth valve 276 into product dispense vials 222, 254, and/or 264. Once the product dispense vials have received the appropriate amount of fluid, needle plate lifting mechanism 312 is actuated to raise needle plate 310 so that needles 280, 282, and 284 and vent cannulas 236, 262 and 272 are raised clear of vial retaining plate 308. The product dispense vials may be removed with their individual shield blocks for transfer towards an end use. If needles 280, 282, and 284 and vent cannulas 236, 262 and 272 are maintained within a controlled environment, it is possible that a new set of product dispense vials may be provided under needle plate 310 so that needles 280, 282, and 284 and vent cannulas 236, 262 and 272 are urged through the respective septums by needle plate lift mechanism 312 for a new round of dispensement. At all times the feed flowpath and filtrate flowpaths remain within the lead shielded laminar flow cabinet so as to minimize operator exposure to any radioactive fluid product remaining therein.

Again, it is contemplated that the interior volume of pump 242 may be smaller than either of vials 222, 254, and 264. Therefore, pump 242 would likely undergo multiple intake and expulsion cycles to direct the feed fluid to its appropriate destination. Alternatively, pump 242 may have a large interior volume which is sufficient to hold and expel all of the source fluid in a single expulsion stroke. In either case, one of ordinary skill in the art would know to provide the proper actuation control for pump 242 and for first valve 244. As noted hereinabove, actuation of pump 242 and valves 244, 252, 274 and 276 may be directed by an onboard PLC controller or by an off-unit hardware platform which holds and operates dispense cassette 210.

FIG. 5 depicts another dispense cassette 310 of the present invention. Cassette 310 is similar in design and function to cassettes 110 and 210, however the bulk vial and product dispense vials are provided at a location outside of its cassette housing 312. Cassette 310 is depicted after bulk collection vial and product dispense vials have been removed. Cassette 310 fits within the lead shielded laminar flow cabinet so that environmentally controlled air may enter the cassette cavity during fluid dispensing. Alternatively, cassette 310 may be located away from the laminar flow cabinet while a bulk collection vial is located within the flow cabinet and connected as a source for cassette 310.

Housing 312 defines a housing cavity 314 which supports the fluid transfer mechanisms of dispense cassette 310. Housing 312 allows cavity 314 may be either open and accessible by the operator or closed but for the terminal conduits of the fluid flowpaths such that the operator need only be able to connect the bulk vial thereto and disconnect the product vials therefrom. Dispense cassette 310 includes a sterilizing filter 316. Filter 316 is desirably a dead-end design filter in which filters a source fluid into a cleaner filtrate. Dispense cassette 310 provides a feed flowpath 318 through which a source fluid flows from an exterior fluid source through cassette 310. Dispense cassette 310 also provides a filtrate flowpath 320 leading from filter 316 to at least one product dispense vial. Feed flowpath 318 defines a feed passageway 324, filter 316 defines a filter passageway, and filtrate flowpath 320 defines a filtrate flowpath 328. Feed passageway 324 is thus in filtered fluid communication with filtrate passageway 328 through filter 316.

With the product dispense vials connected to needles 280, 282, and 284 as previously described, in an environmentally-controlled environment, the product vials cavities provide the same GMP-compliant environment, such that all of the fluid flowspace beyond filter 316 continues to meet the standards of the controlled environment in which the needles are inserted into the product vials. Likewise vent cannulas may also be provided to extend through the septum of a vial so as to allow any entrapped air within the vial cavity to escape while still maintaining the product filtrate fluid within the vial. The vent cannulas includes an elongate hollow vent conduit body supporting a filtration media therein for allowing air to vent from the vial cavity while maintaining the controlled environment within the vial cavity.

Dispense cassette 310 includes a pump 342 operably connected to feed flowpath 318 for directing a fluid through filter 316. Pump 342 is desirably a syringe pump which is electrically or pneumatically controlled to draw a source fluid therein and to then expel the source fluid back out. A first valve 344 operably connected to feed flowpath 318 provides selectable fluid communication either between pump 342 and bulk collection vial 345 or between pump 342 and filter 316.

Dispense cassette 310 may further include a PLC controller 348 for selectively operating syringe pump 342 and valve 344 so as to direct fluid from fluid source 346 to product dispense vial 322. Associated electrical connections from controller 348 are shown but not labeled in FIG. 5. Alternatively, it is further contemplated that dispense cassette 310 may include connectors for mating with an exterior controller or hardware platform which provides appropriate actuation of the elements within housing 312.

As shown in FIG. 5, dispense cassette 310 provides connections to an integrity test unit 350 for filter integrity testing. For this purpose a second valve 352 is operably connected to feed flowpath 318 so as to provide selectable fluid communication either between pump 342 and filter 316, or the integrity test unit 350 and filter 316. An integrity fluid conduit 355 is connected to second valve 352 and extends outside of housing 312 for connection to integrity test unit 350.

Dispense cassette 310 includes third valve 374 and fourth valve 376 incorporated into filtrate flowpath 320. Third valve 374 is operably connected to filtrate flowpath 320 to provide selectable fluid communication either between filter 316 and a first product dispense vial pierced by needle 380 or between filter 316 and fourth valve 376. Fourth valve 376 is operably connected to filtrate flowpath 320 to provide selectable fluid communication either between third valve 374 and a second product dispense vial pierced by needle 382 or between third valve 374 and a third product dispense vial pierced by needle 384.

Each dispense needle defines a opposed first and second open ends and an elongate needle flowpath extending in open fluid communication therebetween. Each of needles 380, 382, and 384 have a cross-sectional diameter which ensures that the septum through which it is inserted is able to fully seal about the needle so as to maintain the environmental integrity of its respective vial cavity as well as to re-seal as the needle is withdrawn therefrom.

In operation, a bulk fluid source 346 is connected to feed flowpath 318. Fluid transfer through cassette 310 is accomplished by pump 342, while valve 344 is properly actuated, to draw the fluid from the bulk fluid source into pump 342 itself. Valve 344 is then actuated to allow pump 342 to expel the fluid from pump 342 towards second valve 352. Valve 352 may be actuated to allow a fluid directed by integrity test unit 350 to impinge on the filter media of filter 316 so that a quality assessment of the filter may be performed. Valve 352 may then, or alternatively, be actuated to direct the fluid flow from pump 342 through filter 316 into filtrate flowpath 320. The purified fluid may then be directed, according to the actuation of third valve 374 and fourth valve 376 into the product dispense vials through needles 382, 384 or 386.

Once the product dispense vials have received the appropriate amount of fluid, they may be removed from the needles and transported towards an end use. If needles 380, 382, and 384 and the associated vent cannulas are maintained within a controlled environment, it is possible that a new set of product dispense vials may be provided for connection and a new round of dispensement. It may be desirable to at all times maintain the feed flowpath and filtrate flowpaths within a lead shielded laminar flow cabinet so as to minimize operator exposure to any radioactive fluid product remaining therein and allow for subsequent connections to new product dispense vials.

Again, it is contemplated that the interior volume of pump 342 may be smaller than either of vials 322, 354, and 364. Therefore, pump 342 would likely undergo multiple intake and expulsion cycles to direct the feed fluid to its appropriate destination. Alternatively, pump 342 may have a large interior volume which is sufficient to hold and expel all of the source fluid in a single expulsion stroke. In either case, one of ordinary skill in the art would know to provide the proper actuation control for pump 342 and for first valve 344. As noted hereinabove, actuation of pump 342 and valves 344, 352, 374 and 376 may be directed by PLC controller 348 or by an off-unit hardware platform which controls operation of dispense cassette 310.

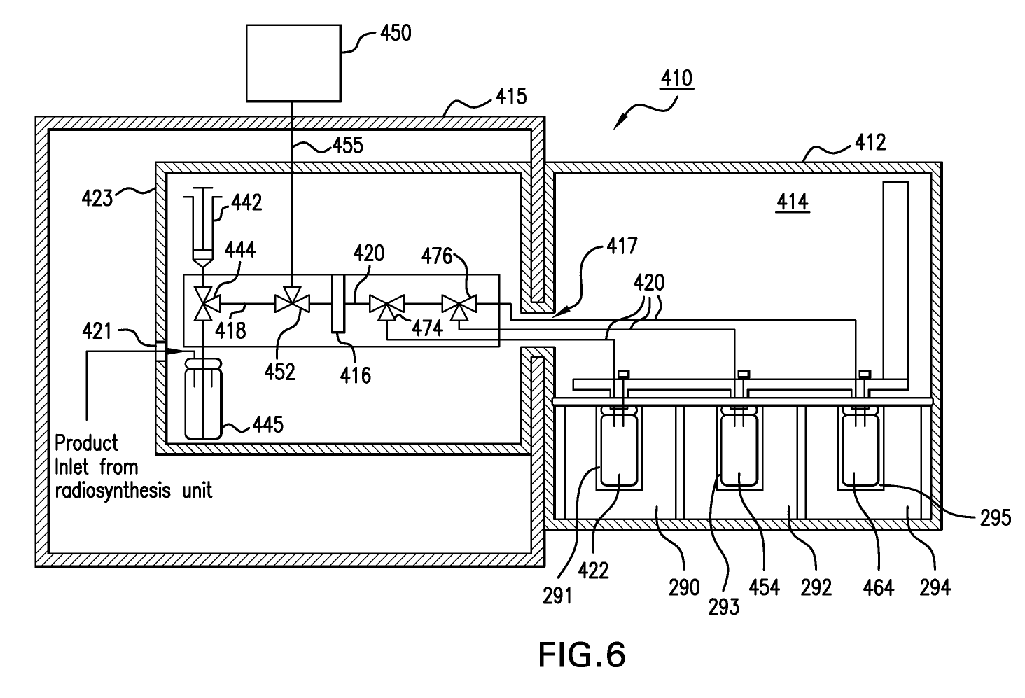

FIG. 6 depicts another dispense cassette 410 of the present invention. Cassette 410 effectively incorporates all of the same internal components as dispenser cassette 210 so the numbering nomenclature will be retained for this description. However, cassette 410 includes a cassette housing 412 which is shaped in a manner that allows a portion of cassette 410 to extend through an opening in a surface of a laminar flow cabinet 416 while the remainder of cassette 410 remains physically outside the laminar flow cabinet. Cassette housing 412 is sealed such from the ambient environment so that cassette cavity 414 is in sealed fluid communication with the interior cavity of the laminar flow cabinet. Cassette 410 therefore allows a significant portion of its fluid transfer apparatus to remain within the shielded enclosure of the laminar flow cabinet to further reduce operator exposure while handling the shield blocks or product dispense vials.

It is further contemplated that housing 412 is provided mechanically separable from the internal components such that all of the internal components may be switched out after dispensing. Connections to a source of feed fluid and to the integrity test unit may be made under the lead enclosure of the laminar flow cabinet. Housing 414 will thus provide an adaptor for expanding the environment of the laminar flow cabinet 416. Typically, the volume of housing 414 outside of the laminar flow cabinet may be about 15625 cm³ [25 cm×25 cm×25 cm]. The laminar flow cabinet includes a hood defining a pass-through hole 417 of 30-40 mm diameter accommodate housing 412. It envisaged that the two enclosures will be designed to allow the air flow from the laminar flow cabinet to also pass through cavity 414. The external laminar flow cabinet 412 will house the shielded product vial transport containers and needle plate lifting mechanism, whilst the internal enclosure will house the cassette and syringe actuation hardware.

In use, a sterile bagged kit will be opened within the external laminar flow cabinet where the assembled needle plate and associated vial clips and product vials will be positioned in the shielded containers. During this process, the needles penetrating the product vials cannot be moved or disturbed. The needle plate will connect to the plate lifting mechanism. The vial retaining plate will slot into position (n.b. the purpose of the vial retaining plate is to prevent the vials lifting from the shielded containers whilst the needle plate withdraws the needles from the product vials—it is envisaged that this plate will be cleanable and not removed from the laminar flow cabinet).

Once the product vials are in position, the valve/filter cassette, syringe and collect vial can be passed through to the internal enclosure and placed onto the actuation hardware. From a health and safety perspective, additional secondary shielding may be required outside the laminar flow cabinet to protect the operator from the unshielded transfer lines within the cabinet. Alternatively, if sufficient resource and infrastructure are available, a lead shielded laminar flow cabinet can be attached to the non-GMP hot-cell to house the entire dispensing system.

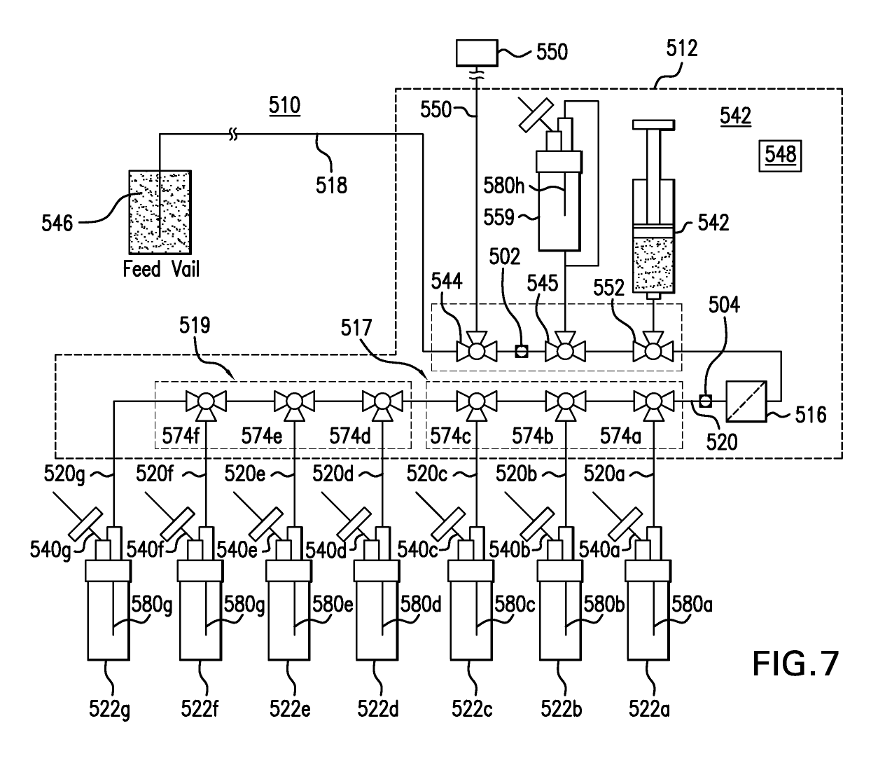

FIG. 7 depicts a dispense system 510 incorporating gas detectors 502 and 504 for detecting a gas bolus within the fluid conduits. Dispense system 510 includes a housing 512 defining a cavity 542 in which is supported a first manifold supporting valves 544, 545, and 552. Valve 544 directs fluid from a bulk collection vial 546 towards valve 545. Valve 544 also provides an input to allow fluid to be directed from an integrity tester 550 towards valve 545. The integrity test fluid is directed against the filter membrane of filter 516 to detect any failure in the filter. Valve 545 directs fluid flow between valve 544 to valve 552 or towards a gas-venting vial 559. A 20 ml syringe pump 542 is connected to valve 552 so as to draw fluid from the feed vial 546 thereinto and to then dispense fluid out from the manifold and towards filter 516. Beyond filter 516, fluid is directed to the serially-connected first and second dispense manifolds 517 and 519 which provide the valving 574a-f and fluid conduits 520a-g to direct the dispensed fluid to the product dispense vials 522a-g, respectively. Each of the product vials 522a-g and the gas-venting vial 558 include an open container body sealed by an elastomeric septum so as to define an enclosed vial cavity. A fluid delivery needle 580a-h is supported at the end of each respective conduit segment extending freely from the manifolds. These fluid delivery needles are each inserted into a septum of one of the vials 522a-g and 559. Each of the product vials 522a-g and gas-venting vial 559 further support a vent needle 540a-g inserted through its septum to allow for entrapped gas to escape from the vial as it is displaced by fluid.

The present invention contemplates that, for a 20 ml syringe pump, and filtrate passageway less than approximately 50 cm in length and about 1 mm in diameter, multiple fills are possible without first venting the syringe prior to product vial fill. Should the length and the dimensions of the tubing result in accumulation of gas in the syringe, then there will be a gas cushion on top of the product within the syringe pump. This gas should be vented prior to dispense in order to increase accuracy and robustness of the dispensing. Without venting, pulling gas the plunger will generate a under pressure, and pushing the plunger will generate an over pressure which results in compression of the gas which adds inaccuracy in the syringe motor control. Initial experiments indicate that a tube of 1.5 m results gives 2-3 ml of gas while pulling, and 1-2 ml while pushing, and if the gas is pushed all the way out the filter will be unusable as the filter is hydrophilic and will prevent gas from passing through the membrane. Forcing gas through threatens to breach the filter integrity and require rejection of the entire batch from clinical use.

For increased accuracy of the venting operation a gas/fluid detector 502 is installed that will reduce or eliminate product loss as system 510 will be able to accurately detect a bolus. The location of detector 502 may be between valves 544 and 545, or between valves 545 and 552 depended on process response delay. It is expected that such a solution will increase robustness and the process will be less challenging to validate as most gas is vented prior to dispensing which ensures filter operation. Additionally, in order to automatically detect air bubbles when performing the filter integrity bubble point test, an additional gas/fluid detector 504 may be installed between filter 516 and valve 574a. Operation and control of the system 510 is contemplated to be provided by either onboard electrocontroller 548 or from outside of housing 512.

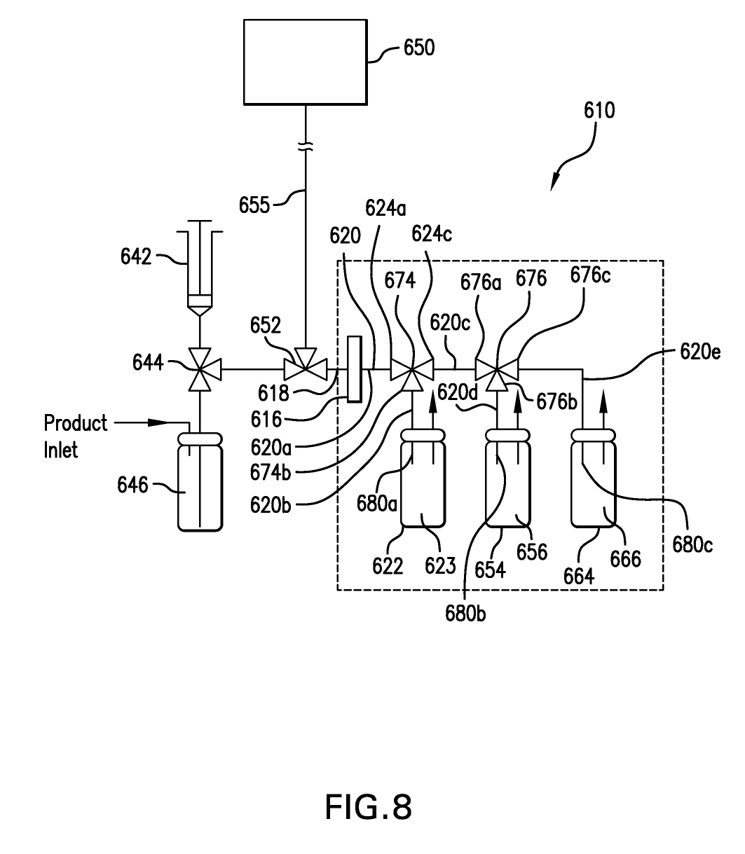

FIG. 8 depicts a kit 600 of the present invention. Kit 600 provides a fluid pathway 610 to be attached to the output port of a dispense system. Fluid pathway 610 includes a filtrate flowpath 612 extending between a sterile filter 614 positioned across one end of fluid pathway 610 and the product cavities of various product vials provided with the kit.

Filtrate flowpath 612 further includes a first and second three-way valve 616 and 618, each controlling fluid flow from an input port 620, 630 thereof to up to two output ports 622, 624 and 632, 634, respectively, thereof. Filtrate flowpath 612 further includes a first segment 640 of fluid conduit connected to input port 620, a second segment 642 of fluid conduit connected to first output port 622, and a third segment 644 of fluid conduit connected to second output port 624 of valve 620. Conduit segment 644 extends between output port 624 to input port 630 of valve 618. A conduit segment 646 extends from first output port 632 of valve 618, while conduit segment 648 extends from second output port 634 of valve 618. Conduit segment 642 supports an elongate hollow needle 650 at the free end thereof for insertion into the cavity 602 of a first product vial 601. Similarly, conduit segments 646 and 648 each support an elongate needle 652 and 654 for insertion into the cavity 604 and 606 of second and third product vials 603 and 605, respectively. Each of product vials 601, 603, and 605 include an open-ended container body sealed by an elastomeric septum so as to define the sterile vial cavity 602, 604, and 606, respectively. The septums are penetrable by the needles of the kit.

Filter 614 spans across said fluid pathway 610 and defines a filtrate passageway 660 therethrough in fluid communication with the fluid passageway of first segment 640 of filtrate flow path 612. As provided in kit 600, filtrate flowpath 612 is provided in, and sealed to maintain, a controlled environment suitable for dispensing a pharmaceutical fluid product therethrough. Kit 600 is thus adaptable for connection to a dispenser system and then directing fluid from the dispenser system to the product vials. Desirably, kit 600 is stored and transported in a sealed elastomeric bag which also provides a controlled environment. For both the filtrate flowpath 612 and the elastomeric bag, the controlled environments described are GMP-compliant for sterile fluid transfer operations. The present invention contemplates that kit 600 may be provided in the sterile bag with the product vials either separated off from the needles or with the needles inserted therein. Should the product vials be provided separated from the needles, the bag should be opened and the needles inserted into the vials in an environmentally controlled environment. After dispensement into the product vials, each may be removed from its respective needle and stored or transported to the end user. Removing the product vials in a controlled environment, such as under a laminar flow hood, allows for subsequent product vials to be connected for subsequent dispensing.

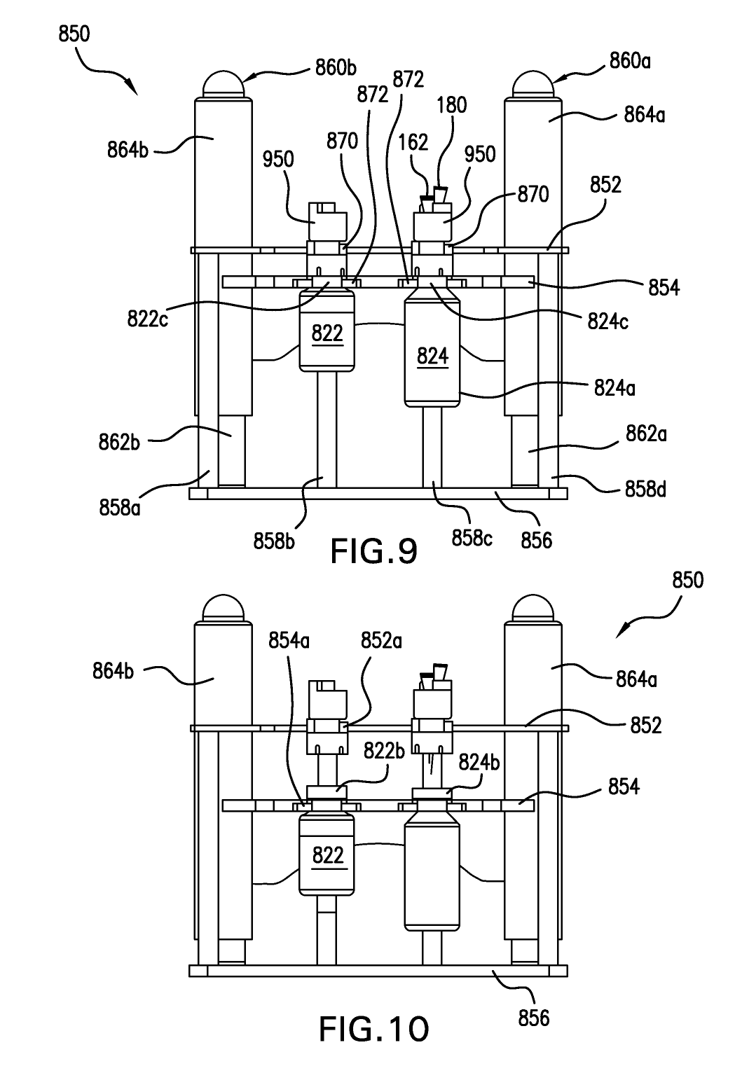

FIGS. 9 and 10 depict another needle plate lifting mechanism, or lift, 850 of the present invention. Lift 850 accommodates a first and second dispense vial 822 and 824. Vials 822 and 824 are shown to be of different sizes so as to illustrate that the operating principle of lift 850 may be applied to dispense vials of varying sizes and capacities. Each of vials 822 and 824 provide a container body 822a and 824a, respectively, as described hereinabove. Vials 822 and 824 also provide vial caps 822b and 824b which seal the vials with a pierceable elastomeric septum. The caps provide open access to their respective septums to allow each to be pierced by a fluid needle and vent needle as previously described. Additionally, vials 822 and 824 include a relatively narrow neck portion 822c and 824c between their container body and cap. The provisions of neck portions 822c and 824c allows each vial to be held thereat by lift 850 as will be described more fully hereinbelow. The present invention contemplates that the lifts may be provided as part of a kit with the dispense cassettes of the present invention or, alternatively, as a separate device for use with conventional dispense systems.

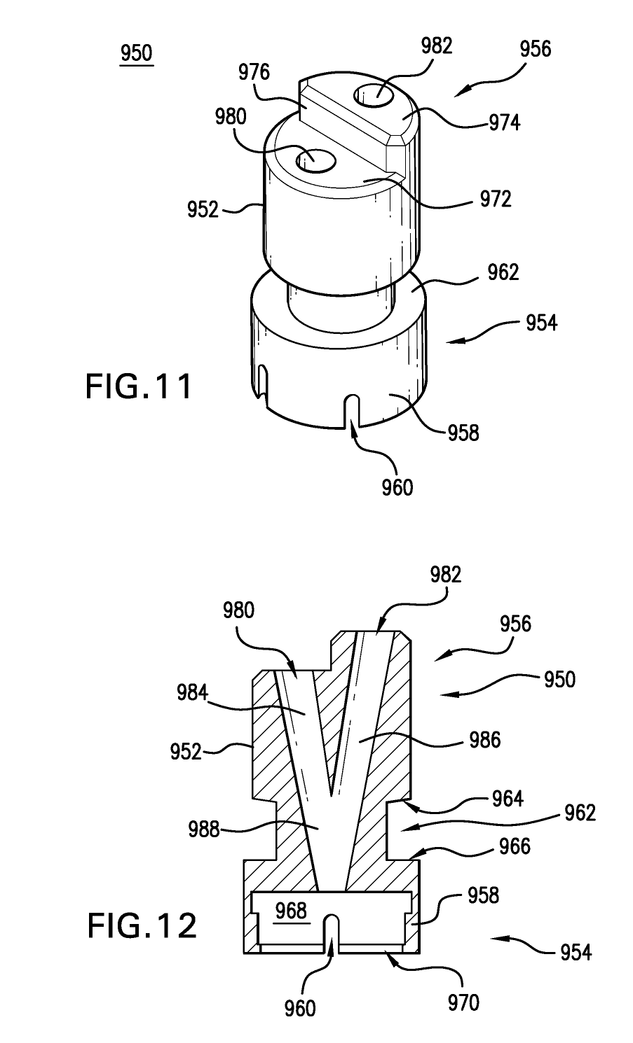

Lift 850 includes an elongate planar needle plate 852 and an elongate planar vial plate 854 which may be urged towards and away from each other while each holds one or more dispense vials or one or more dispense and vent needles. The dispense and vent needles are contemplated to be either held directly by the needle plate (as described hereinabove) or by a needle clip of the present invention, described more fully with the description of FIGS. 11 and 12. Lift 850 also includes an elongate planar base 856 which supports upstanding posts 858a-d as well as first and second pistons 860a and 860b. Base plate 856 and needle plate 852 are each fixed to opposing ends of posts 858a-d. Pistons 860a and 860b include a piston rod 862 fixed to base 856 and a overlying and slideably extendable piston cylinder 864a and 864b. Vial plate 854 is affixed to piston cylinders 864a and 864b so as to moveable towards and away from needle plate 852. For each vial to be accommodated by lift 850, needle plate 852 and vial plate 854 define an elongate open notch 870 and 872, respectively, for receiving a needle clip or the neck portion of a vial. The needle and vial plates provide a parametrical edge 852a and 854a about their respective notches 870 and 872 for engaging the vial clip and vial neck, respectively.

For simplicity, operation of lift 850 will be described for vial 822 although it will be clear to one of ordinary skill in the art that similar procedures would be followed for vial 824 or any similarly-constructed vial. Operation of lift 850 is contemplated to be controlled by the controller of a dispense cassette of the present invention, although it is further contemplated that actuation may be controlled separately. Lift 850 is designed to begin from the position shown in FIG. 9, with the needle and vial plates brought in near proximity to one another, with piston cylinders 864a and 864b in the extended configuration. In this configuration an operator loads vial 822, with vial clips 950 attached, onto lift 850 such that the neck portion 822c is received within notch 872 such that vial 822 is held about neck portion 822c by edge 854a. Similarly, in this same motion, vial clip 950, at trench 962 (described more fully for FIGS. 11 and 12), is received in notch 870 and held thereabout by edge 852a. The fluid needle 180 and vent needle 162 (described hereinabove) may be inserted through vial clip 950 and vial cap 822a either before or after loading the vial and clip onto lift 850, at the operator's discretion. Similarly, Needle 180 may be connected to a dispense system as appropriate for the present invention.

During dispense of a fluid into vial 822, lift 850 holds vial 822 and vial clip 850 in place. Once dispensing is completed, pistons cylinders 860a and 860b may be retracted away from needle plate 852 so as to pull vial 822 clear of both the vent needle and the fluid needle. The operator may then remove vial 822 from lift 850.

It will be appreciated by those of skill in the art that the linkage mechanism of lift 850 may be refit so that needle plate 852 is affixed to cylinders 860a and 860b such that separation of vial 822 from clip 950 is accomplished by extending piston cylinders to raise needle plate away from the vial plate, which in this case is affixed to the opposed ends of posts 858a-d from base 85. Such a configuration, described for the embodiment, e.g., in FIG. 6 would similarly work for lift 850.

FIGS. 11 and 12 depict a vial clip 950 of the present invention. Vial clip 950 includes an elongate clip body 952 typically formed from a plastic material that is suitable for use in pharmaceutical dispense operations. Clip body 952 includes opposed first and second ends 954 and 956, respectively. First end 954 is adapted to be removably attached about the cap of a vial and for this purpose body 952 defines a number of deflectable petals 958 freely extending to end 954. Clip body 952 defines open grooves 960 about each petal 958 so as to facilitate the deflection of the petals during attachment to and removal from a vial cap. Clip body 952 also defines an annular trench 962 between opposed sidewalls 964 and 966. Trench 962 is adapted to provide mating engagement between clip 950 and one plate of a vial lift mechanism of the present invention by receiving the plate's opposed notch edges therein.

As seen in FIG. 12, first end 954 defines a vial cap cavity 968 into which the cap of an inserted vial is received. Additionally, each of petals 958 supports an inwardly facing detent 970 which will deflect away from a vial cap during insertion and removal operations while also providing an interfering holding force against the vial cap when fully inserted into cavity 968.

Second end 954 includes a first transverse surface 972 and a second transverse surface 974 longitudinally separated by an upstanding headwall 976. Surface 972 defines a first aperture 980 and surface 974 defines a second aperture 982. Cap body 954 defines a first elongate passageway 984 extending in fluid communication between aperture 980 and cavity 968. Cap body 954 also defines a second elongate passageway 986 extending in fluid communication between aperture 982 and cavity 968. Each of passageways 984 and 986 are arranged to provide for insertion of a needle therethrough so as to direct the needle through the septum of an inserted vial cap and thereby place the needle passageway in fluid communication with the vial cavity. As shown in FIG. 12, clip body 952 defines passageways 984 and 986 in a longitudinally-tapering orientation such that the two passageways join at a junction 988 in registry with cavity 968. Junction 988 is located so as that the pierceable septum of a vial cap is positioned in underlying registry therewith. Desirably, one of passageways 984 and 986 will provide transit of a fluid delivery needle while the other of passageways 984 and 986 will accommodate a vent needle therethrough so that each pierce an underlying vial cap septum.

Clip 950 provides a convenient and reliable assembly for holding and directing each needle through the septum of a vial so as to enable proper fluid dispensement while also holding each needle within clip 950 as the vial and clip 950 are separated after dispensing operations are complete. Due to the tapered alignment of passageways 984 and 986, it is contemplated that clip 950 will be attached to a vial prior to either the fluid delivery needle or the vent needle being inserted therethrough prior to dispensing operations. However, the present invention contemplates that, space permitting, one or both of passageways 984 and 986 may extend longitudinally through clip body 952 so as to more easily allow a vial clip of the present invention to hold the two needle bodies as the clip is attached to a vial cap.

While the particular embodiment of the present invention has been shown and described, it will be obvious to those skilled in the art that changes and modifications may be made without departing from the teachings of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A dispenser cassette for dispensing a fluid provided by a fluid source, said cassette comprising:
a housing defining a housing cavity, said housing supporting in said cavity
an elongate feed flowpath defining a delivery passageway;
an elongate filtrate flowpath defining a delivery passageway;
a sterilizing filter providing a filter element defining a filtration passageway positioned in fluid communication between the delivery passageways of said feed and filtrate flowpaths;
a pump means operably connected to said feed flowpath for directing a fluid through said filter element;
a first valve providing selectable fluid communication between one of said pump and the fluid source and said pump and said filter;
at least one product dispense vial having a vial cavity, wherein said vial cavity is provided in fluid communication with said delivery passage of said filtrate flowpath, and wherein said vial cavity and said delivery passage of said filtrate flowpath is provided as an environmentally-controlled volume; and
a controller for selectively operating said syringe pump and said valves so as to direct fluid from the fluid source to said at least one product dispense vial.

2. A dispenser cassette of claim 1, further comprising:
an integrity test flowpath;
a second valve providing selectable fluid communication between said delivery passageway of said feed flowpath and one of said integrity test flowpath and said filter.

3. A dispenser cassette of claim 1, further comprising:
a second product dispense vial;
a third valve providing selectable fluid communication between said filter and one of said at least one product dispense vial and said second dispense vial.

4. A dispenser cassette of claim 3, further comprising:
a third product dispense vial;
a fourth valve providing selectable fluid communication between said filter and one of said second product dispense vial and said third dispense vial.

5. A dispenser cassette of claim 1, further comprising:
a bulk collection vial having a bulk collection cavity positioned in intermediate fluid communication between the fluid source and said first valve.

6. A dispenser cassette of claim 1, wherein said pump means comprises a syringe pump.

7. A dispenser cassette of claim 1, wherein said at least one product dispense vial further comprises a container body having an opening sealed by an elastomeric septum, wherein said filtrate flowpath removably extends through said septum.

8. A dispenser cassette of claim 7, further comprising a first dispense needle supported on said filtrate flowpath, said first dispense needle having opposed first and second open ends and defining an elongate needle flowpath extending therebetween, said first dispense needle extending through said septum of said at least one product dispense vial.

9. A dispenser cassette of claim 8, wherein said at least one product dispense vial further comprises a vent conduit extending through said septum, said vent conduit supporting a filtration media therein for allowing air to vent from said vial cavity while maintaining the controlled environment of said vial cavity.

10. A dispenser cassette of claim 3, wherein said second product dispense vial further comprises a container body having an opening sealed by an elastomeric septum, wherein said filtrate flowpath removably extends through said septum.

11. A dispenser cassette of claim 10, further comprising a second dispense needle supported on said filtrate flowpath, said second dispense needle having opposed first and second open ends and defining an elongate needle flowpath extending therebetween, said second dispense needle extending through said septum of said second product dispense vial.

12. A dispenser cassette of claim 11, wherein said second product dispense vial further comprises a second vent conduit extending through said septum thereof, said second vent conduit supporting a filtration media therein for allowing air to vent from said vial cavity of said second product dispense vial while maintaining the controlled environment of its vial cavity.

13. A dispenser cassette of claim 4, wherein said third product dispense vial further comprises a container body having an opening sealed by an elastomeric septum, wherein said filtrate flowpath removably extends through said septum.

14. A dispenser cassette of claim 13, further comprising a third dispense needle supported on said filtrate flowpath, said third dispense needle having opposed first and second open ends and defining an elongate needle flowpath extending therebetween, said third dispense needle extending through said septum of said third product dispense vial.

15. A dispenser cassette of claim 14, wherein said third product dispense vial further comprises a third vent conduit extending through said septum thereof, said vent conduit supporting a filtration media therein for allowing air to vent from said vial cavity of said third product dispense vial while maintaining the controlled environment of its vial cavity.

16. A dispenser cassette of claim 4, wherein at least one of said first valve, third valve, and fourth valve is a stopcock valve.

17. A dispenser cassette of claim 2, wherein said second valve is a stopcock valve.

18. A dispenser cassette of claim 1, further comprising a sterile bag enclosing said dispenser cassette.

19. A dispenser cassette of claim 8, further comprising a needle support plate urgeable between a first position in which said dispense needle extend into the cavity of said at least one product dispense vials and a second position in which said dispense needle is retracted clear of said at least one product dispense vial.

20. A dispenser cassette of claim 19, further comprising an actuator for moving said needle support plate between said first and second positions.

21. A dispenser cassette of claim 1, further comprising a flowhood adaptor, said flowhood adaptor comprising a flowhood adaptor housing defining an adaptor cavity for receiving said dispenser cassette therein, said flowhood adaptor housing further defining at least a first aperture therethrough for conducting airflow therethrough, said first aperture being positionable within a laminar flow cabinet.

22. A laminar flow hood adaptor having an adaptor cavity connectable to a first laminar flow hood having a first cavity so as to allow a fill conduit located within said first cavity of said first laminar flow hood to extend into said adaptor cavity, wherein said adaptor cavity contains the dispenser cassette of claim 1.

23. A dispenser cassette comprising:
a cassette housing;
a sample withdrawal conduit;
a fluid integrity conduit;
an internal transfer conduit;
at least one product delivery conduit having a free end supporting a needle;
a sterilizing filter connected said product delivery conduit of the dispenser cassette such that any fluid passing through said at least one product delivery conduit must flow through said sterilizing filter;
a syringe pump;
a first valve connected between said sample withdrawal conduit, said syringe pump, and said internal transfer conduit;
a second valve connected between said internal transfer conduit, said fluid integrity conduit, and said at least one product delivery conduit;
a controller for operating said pump and said valves;
at least one product vial having a vial cavity; and
a needle support plate urgeable between a first position in which said needle supported at said free end of said at least one product delivery conduit extend into the vial cavity of said at least one product vial and a second position in which said needle is retracted clear of said at least one product vial.

24. A dispenser cassette of claim 25, further comprising:
a bulk collection vial having a container cavity, wherein said sample withdrawal conduit is connected to said bulk collection vial such that contents within said container cavity may be withdrawn through said sample withdrawal conduit by the action of said syringe pump.

25. A dispenser cassette of claim 24, further comprising a sterile delivery package containing said dispenser cassette.

26. A dispenser cassette of claim 24, further comprising a laminar flow hood adaptor defining a adaptor cavity which connects to a laminar flow hood having a primary hood cavity, such that said adaptor cavity is in fluid communication with said primary hood cavity so as to conduct GMP-compliant air flow from said primary hood cavity through said adaptor cavity, and wherein said adaptor cavity supports said dispenser cassette therein.

27. A kit for a dispenser system, said kit comprising:
an elongate fluid pathway, said pathway comprising at least one three-way valve for controlling fluid flow from an input port of said valve to up to two output ports of said valve, said pathway further comprising a first segment of fluid conduit connected to the input port of said at least one valve, a second segment of fluid conduit connected to the first output port of said at least one valve, and a third segment of fluid conduit connected to the second output port of said at least one valve;
a first elongate hollow dispense needle connected to said second segment of fluid conduit, a second elongate hollow dispense needle connected to said third segment of fluid conduit,
a fluid filter spanning across said fluid pathway such that said filter defines a filtrate passageway therethrough in fluid communication with the fluid passageway of said first segment of fluid conduit,
wherein said fluid pathway between said filter and said at least one valve embodies a controlled environment suitable for dispensing a pharmaceutical fluid product therethrough;
said kit adaptable for connection to a dispenser system and directing fluid from said dispenser system to at least one product container.

28. The kit of claim 27, further comprising a container enclosing said kit, said container defining an interior cavity, said cavity comprising a controlled environment for holding said kit.

29. The kit of claim 27, wherein said cavity comprises a GMP-compliant environment.

30. The kit of claim 27, further comprising a first product vial comprising an open-ended container body sealed by an elastomeric septum so as to define a sterile vial cavity, and a second product vial comprising an open-ended container body sealed by an elastomeric septum so as to define a sterile vial cavity, said septums penetrable by one of said needles of said kit.

31. The kit of claim 30, wherein said first needle extends through the septum of said first product vial and said second needle extends through the septum of said second product vial, said kit providing a controlled environment within said fluid pathway extending between said filter and each of said vial cavities.

32. The kit of claim 27, further comprising a manifold, said manifold comprising a manifold body supporting said at least one valve therein, said manifold body further defining a channel network for support portions of said first, second, and third fluid conduit segments.

33. A vial clip for interfacing between one or more elongate cannulas and a vial cap supporting a septum to be pierced by the one or more cannulas, said vial clip comprising:
A clip body having opposed first and second ends, said first end defining a vial cap cavity for receiving the vial cap, said clip body further defining one or more elongate open passageways extending in fluid communication between said second end and said vial cap cavity, said passageways adapted to receive a needle therethrough for piercing the septum of the vial cap.
